(19) United States
(12) Patent Application Publication
(10) Pub. No.: US 2010/0141988 A1
(43) Pub. Date: Jun. 10, 2010

(54) INFORMATION PROCESSING APPARATUS AND INFORMATION PROCESSING METHOD

(75) Inventor: Hiroshi Kai, Tokyo (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/630,625

(22) Filed: Dec. 3, 2009

(30) Foreign Application Priority Data
Dec. 5, 2008 (JP) 2008-311338

(51) Int. Cl. G06F 15/00

(52) U.S. Cl. 358/1.15

(57) ABSTRACT

An information processing apparatus includes a data transfer unit configured to transfer print data to an image processing apparatus which is capable of communicating via a network, wherein the data transfer unit recognizes a status of a job based on information of the job on a print queue and pauses or resumes processing to transfer the print data according to the recognized status.

### BACKGROUND OF THE INVENTION

1. Field of the Invention

The present invention relates to an information processing apparatus and an information processing method.

2. Description of the Related Art

Conventionally, a typical printing system includes a color printer capable of color printing, a host computer which controls the printer and generates print data, and a communication interface which connects the color printer and the host computer to each other. An operating system is running on the host computer and various types of software are running on the operating system. When printing various documents created by application software, the application software, a printer driver and the operating system call a function according to a predetermined step to transmit data therebetween, thereby generating a print command. Then, the generated print command is transmitted to a printer to cause the data to be printed by the printer. Some of the printer drivers can perform a bidirectional communication with the printer by utilizing a communication function provided by the operating system and display status information of the printer on a screen. Such a printer driver can improve convenience for users.

A typical operating system includes a print queue where a print job from the application software is once spooled to be sequentially subjected to processing. Owing to an operation of the print queue, the application software can be off-loaded from the print processing before the printer completes the print processing.

When the user desires to pause the processing of the print job spooled on the print queue, the user performs a predetermined operation in an operation unit of the print queue in the case of a Graphic Device Interface (GDI) print path as one of the print systems of Microsoft Windows (registered trademark). Following the above predetermined operation, the operating system instructs a module of the printer driver, which is referred to as the “print processor,” to pause the print processing. Accordingly, the print processor pauses generation of data of the print job, thereby pausing the print processing. ((Microsoft Developer Network, Windows Driver Kit/Print Devices/Control Print Processor, [online], (msdn.microsoft.com/en-us/library/aa506532.aspx))).

On the other hand, an XPS print path is recently developed as a new print system for Microsoft Windows and the XPS print path is installed in Windows Vista as one of the standard print systems. In the print processing according to the XPS print path, XPS (Extensible Markup Language (XML) Pater Specification) data, which is independent from the model of a printer, is employed as data to be spooled on the print queue. Further, in the XPS print path, a part of a component of the printer driver is provided with a mechanism which is referred to as the “filter pipeline”. According to the mechanism, one or a plurality of filter module (s) is/are used for a page layout, a rendering, generation of print data to be sent to the printer, or the like. The filter pipeline also functions as the print processor in the above-described GDI print path. However, in the XPS print path, the operating system is not allowed to send the pausing command to the filter module corresponding to the print processor. Therefore, it is not possible for the conventional method to pause the print processing.

Further, in the case of the above described GDI print path, data of the print job spooled on the print queue includes Enhanced Metafile (EMF) format data which is a general graphic language independent from the model of a printer, and RAW format data which is unique to a specific printer. The EMF format data is subjected to processing per page unit in the print processor. Accordingly, the generation of the data of the print job can be paused at each page break. As such, the printer can pause the print processing after discharging a sheet on which a certain page is printed and before a sheet for the next page is fed. On the other hand, according to the RAW format data, the print processor cannot determine where the page break is, so that the print processing may be paused on the way of printing a certain page, i.e., before discharging the fed sheet as a result of pausing processing of the generation of the data of the print job.

As described above, in the XPS print path, there is an issue in the conventional method that the print processing cannot be paused. Thus, the XPS print path is not as convenient as the conventional GDI print path.

Even in the case of the GDI print path, there may be the following issue if the RAW format data is spooled on the print queue. More specifically, the print processing may be paused on the way of printing a page. In this case, for example, a malfunction printing, such as a streak on a boundary of the sheet before and after pausing the print processing, may occur with an ink jet printer.

### SUMMARY OF THE INVENTION

The present invention is directed to an information processing apparatus which can pause print processing in an XPS print path, as well as which can pause print processing, for example, at a page boundary even if RAW format data is spooled in a GDI print path.

According to an aspect of the present invention, an information processing apparatus includes a data transfer unit configured to transfer print data to an image processing apparatus which is capable of communicating via a network, wherein the data transfer unit recognizes a status of a job based on information of the job on a print queue and pauses or resumes processing for transferring the print data according to the recognized status.

According to an exemplary embodiment of the present invention, the print processing can be paused in the XPS print path as well as the print processing can be paused, for example, at the page boundary even if the RAW format data is spooled in the GDI print path.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates an example of a configuration of an information processing apparatus.

FIG. 2 illustrates an example of a configuration of a print system, which is referred to as the “GDI print path”, among the print systems applicable to the information processing apparatus.

FIG. 3 illustrates an example of data of a print job which a printer can interpret.

FIG. 4 illustrates an example of a configuration of a print system, which is referred to as the “XPS print path, among the print systems applicable to the information processing apparatus.

FIG. 5 illustrates an example of a displayed print queue screen provided by an operating system (OS) in both of the GDI print path and the XPS print path.

FIG. 6 illustrates an example of an operation that all of the spooled print jobs are paused as a whole to print the print jobs by the printer.

FIG. 7 illustrates an example of an operation when only a specific print job is paused.

FIG. 8 is a flow chart illustrating a processing operation of processing to output the print job to the printer in a language monitor (LM).

FIG. 9 is a flow chart illustrating a processing operation of a print processor (PP) when a Graphic Device Interface (GDI) 202 notifies the print processor (PP) to pause the print job as a result that a user operates to pause the print job in the print queue screen provided by an operating system (OS).

FIG. 10 is a flow chart illustrating a processing operation of the PP when the GDI notifies the PP to resume the print job as a result that the user operates to resume the print job in the print queue screen provided by the OS.

FIG. 11 is a flow chart illustrating a processing operation of processing to generate print data by the PP.

### DESCRIPTION OF THE EMBODIMENTS

Various exemplary embodiments, features, and aspects of the invention will be described in detail below with reference to the drawings.

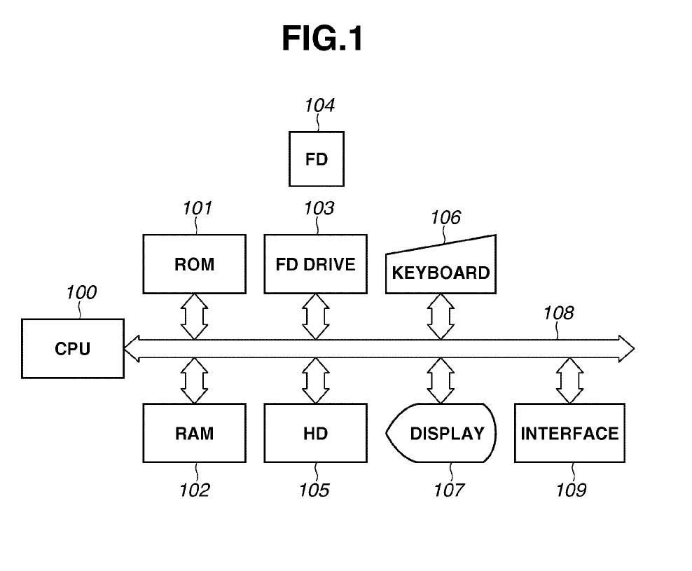

FIG. 1 illustrates an example of a configuration of an information processing apparatus. The information processing apparatus is configured to be capable of communicating with a printer (printing apparatus) as an example of an image processing apparatus via a network interface or a bidirectional interface.

In FIG. 1, a central processing unit (CPU) 100 controls the information processing apparatus as a whole as well as controls each device via a system bus 108. The CPU 100 executes an application program, a printer driver program, an operating system (OS) stored in a hard disk (HD) 105 or a network printer control program of the present exemplary embodiment. The CPU 100 further controls the information processing apparatus to temporarily store information necessary to execute the program, files, and the like in a random access memory (RAM) 102.

A read-only memory (ROM) 101 basically stores a program such as an input/output (I/O) program, font data to be used for document processing, and various pieces of data such as data for a template. The RAM 102 functions as a main memory and a work area for the CPU 100. The RAM 102 also includes an area for storing a variable when a printing area is calculated based on print data generated by the printer driver.

A flexible drive 103 can load a program stored in a flexible disk (FD) 104 as a storage medium into the information processing apparatus. The flexible disk 104 as the storage medium stores a computer readable program.

Examples of the storage medium include, in addition to the flexible disk, a compact disc read-only memory (CD-ROM), a compact disc recordable (CD-R), a compact disc rewritable (CD-RW), a PC (PCMCIA) card, a digital versatile disc (DVD), an integrated circuit (IC) memory card, a magneto optic (MO) disk, and a memory stick.

A hard disk (HD) 105 functions as a large capacity memory and stores an application program, a printer driver program, an operating system (OS), a network printer control program, and associated programs.

A keyboard 106 allows a user to input an order of a device control command to the information processing apparatus.

A display 107 displays a command the user has input via the keyboard 106, a status of the printer, and the like.

A system bus 108 controls a flow of data within the information processing apparatus. An interface 109 functions as an input/output unit of the information processing apparatus. The information processing apparatus transmits/receives data with an external device via the interface 109.

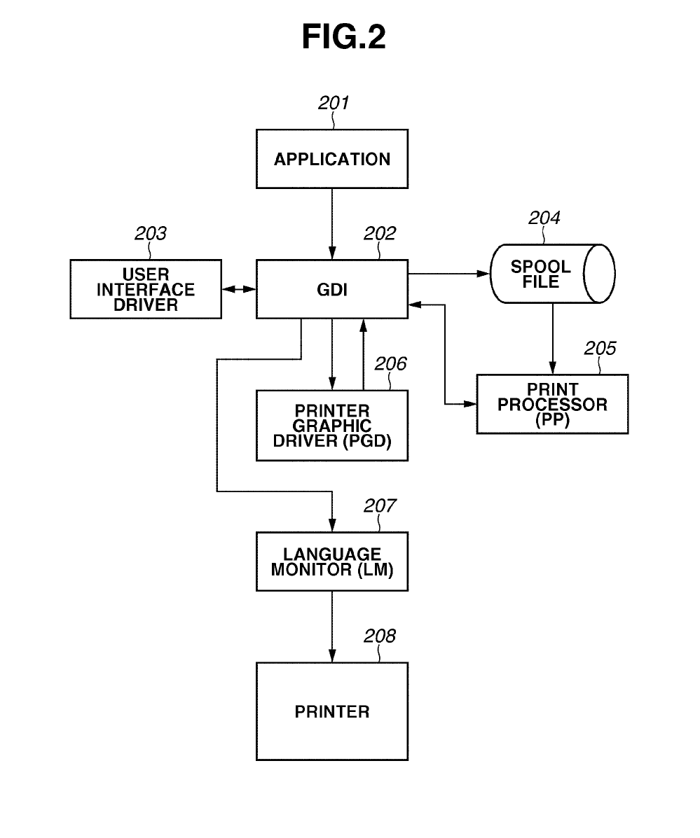

FIG. 2 illustrates an example of a configuration of a print system, which is referred to as the “GDI print path”, among print systems applicable to the information processing apparatus. An operating system of the Windows produced by the Microsoft Company will be utilized in the information processing apparatus. Further, an arbitrary application 201 having a print processing function is installed in the information processing apparatus. Still further, FIG. 2 illustrates an embodiment as an example that a printer 208 is connected to the information processing apparatus via the Internet such as a cable.

The application 201 can set print setting information via a Graphic Device Interface (GDI) 202 with respect to the printer 208. The print setting information includes information necessary for print processing, such as a type and a size of a paper on which a page generated by the application 201 is printed in the printer 208 and a paper feed port of a paper receiving device.

A user interface driver 203 notifies the application 201 via the GDI 202 a list of options which can be set in each print setting information as well as includes an interface which can set various print settings.

Rendering data that the application 201 requests for printing is passed to a Printer Graphic Driver (PGD) 206 via the graphic device interface (GDI) 202 as a rendering module of the OS. The rendering data that the application 201 requests for printing includes print data such as document data and image data.

Accordingly, a print job is generated by the PGD 206 to be output to the printer 208 as a print request.

There are cases that the GDI 202 once spools the data in a spool file 204 in the form of Enhanced Metafile Format (EMF) data according to the setting (spool processing of the OS) and that the GDI 202 spools the data in the spool file 204 in the form of RAW data which is a printer interpretable command set. When spool processing ends, the GDI 202 issues the print request to the print processor (PP) 205.

The PP 205 reads print output information and rendering data from the spool file 204 per page unit. If the data is the EMF data, the PP 205 requests to output the data page by page to the Printer Graphic Driver (PGD) 206 via the GDI 202 to print out the data. Further, since the PP 205 does not recognize a page boundary of the RAW data, the PP 205 requests to print the data after outputting the data to a language monitor (LM) 207 via the GDI 202.

The PP 205 is prepared as the module of the OS. However, it is allowable that the PP 205, which has been customized by a maker of the printer 208, is supplied together with the Printer Graphic Driver (PGD) 206, and the customized PP 205 and the PGD 206 are installed in the hard disk. In the present exemplary embodiment, the customized PP 205 is installed.

The PGD 206, which has received a request for print processing from the PP 205, performs the following rendering processing. More specifically, a GDI rendering engine which is a drawing function of the GDI 202 is utilized to render the rendering data to raster image data according to a print resolution of the printer 208.

The raster image data is multi-valued data which holds colors in the form of multilevel values. The PGD 206 performs color processing to generate halftone data in which a color is separated into color components for respective color inks held by the printer 208.

Generally, a vast amount of memory is required in processing a whole page of the raster image data and the halftone data at one time.

Therefore, the PGD 206 can request processing per band unit to the GDI 202. In this case, the PGD 206 can designate a size of the band. Further, the PGD 206 can request the GDI 202 to change the band size after the processing is completed with respect to a certain band.

Alternatively, the PGD 206 can request the GDI 202 not for a band mode which performs band processing but for an unbanding mode which performs processing per page unit and stores all the rendering data by itself. Then, the PGD 206 can output the rendering data per band unit.

The GDI 202 converts the print setting information into the print command and thus converted print command is subjected to processing in which the converted print command is attached to print data to be printed. The print data with the print command is, then, transmitted to the printer 208.

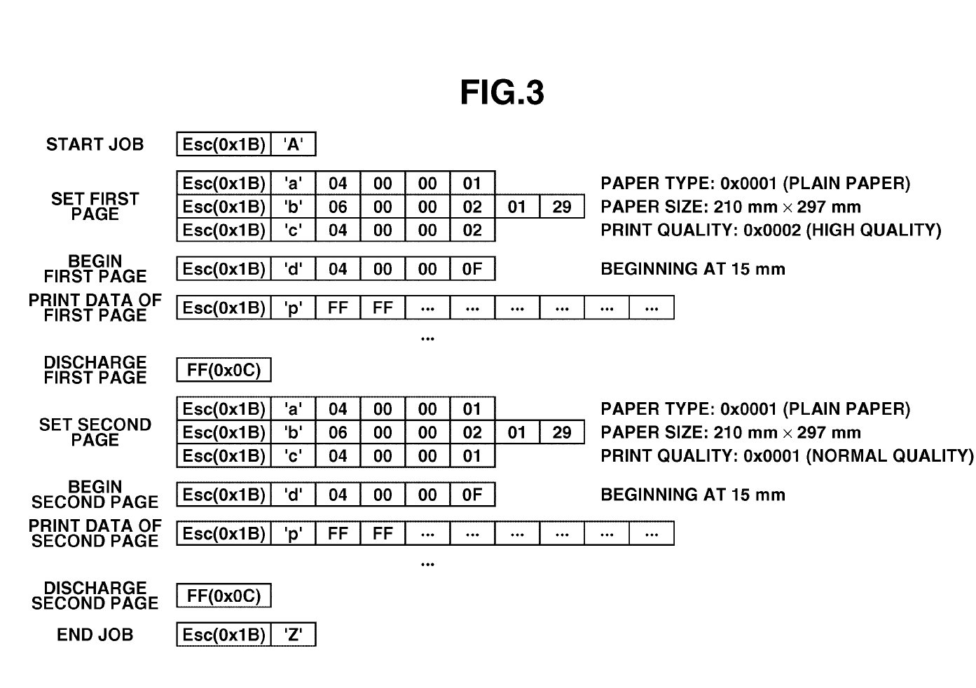

The data output from the PGD 206 is actually output to the LM 207 in the form of a transmission request. The LM 207 separates the print job into packets of a specific size to sequentially output the packets to the printer 208. At this time, the LM 207 analyzes the data of the print job to output the data of the print job to the printer 208, recognizes the boundary between pages, and outputs the print job to the printer 208. In other words, the LM 207 analyzes the data of the print job at the end of transmission processing in which the print job (or print data) is transmitted (output) to the printer 208 and outputs the print job (or print data) to the printer 208 while the LM 207 recognizes the boundary between pages. To pause the print processing at the right boundary between pages, it is provided that there is no retaining data relating to the print job remaining in the information processing apparatus after the processing to output the print job (or print data) to the printer 208 while the LM 207 recognizes the boundary of pages. A recognizing method for the boundary between pages will be described below in detail with reference to FIG. 3.

FIG. 3 illustrates an example of the data of the print job which is interpretable by the printer 208. The data of the print job is made of an escape sequence. To start the print job is declared by a job entry command (Esc A). Then, as a setting of a first page, commands of Esc a, Esc b, and Esc c, which provide settings of a type and a size of a paper and a print quality, are displayed. Sequentially, an Esc d command which instructs a starting position of the paper is displayed, and an Esc p command which stores a bit pattern of the print data is displayed for a single page. At the end of the page, an FF command as a paper discharge order is displayed. The same commands are displayed in a second page, and an Esc Z command is displayed at each end of the jobs to declare an end of the job. Each of the Esc A command, the FF command, and the Esc Z command has a fixed-length without a parameter.

On the other hand, each of the Esc a command, the Esc b command, the Esc c command, the Esc d command, and the Esc p command has a parameter. That is, each command may have a variable length. More specifically, each command has a parameter which indicates a command length. The third byte and the fourth byte of each command are parameters in which a length of a command is represented by two bytes. The third byte represents a lower byte and the fourth byte represents an upper byte. A command length represented by the parameter is a command length after the third byte. For example, the Esc a in the first page in FIG. 3 shows that a length after the parameter of the command length is four bytes. Since, in each of the commands which has the parameter, a length of a part before the parameter of the command length is fixed to two bytes (an Esc command and a command identifier of one byte), the number of bytes in which two bytes are added to the parameter of the command length can be recognized as the number of bytes of the whole command. When the LM 207 analyzes the print job, the command is considered as one byte if the first byte of the command beginning is the FF command, the command is considered as two bytes if the two bytes of the command beginning is the Esc A command or the Esc Z command, and the following two bytes are analyzed in a case other than the above. Accordingly, the LM 207 can recognize the entire length of the command. The LM 207 analyzes the print job by skipping the length of each command in the case of the command in which a content of the parameter is not required to be recognized, thereby reducing a load in analyzing the print job.

In the GDI print path, when the user attempts to pause transfer processing in which the print job is transferred to the printer 208, the user operates the print queue screen provided by the OS to instruct to pause the print job. When the user instructs to pause the print job, the GDI 202 sets a flag, which represents that the print job is now paused, on the job information of the print job. At the same time, the GDI 202 notifies the PP 205 of the printer driver, which processes the print job, that the print job is to be paused. The notification is sent by the GDI 202 calling a function exported by the PP 205. When the user operates to resume the print job now in pause (operates to release the print job from the paused status), the GDI 202 removes the flag which represents that the job information of the print job is once paused to be transmitted. Further, at the same time, the GDI 202 transfers a notification indicating that the job is released from the paused status to the PP 205 of the printer driver which is processing the print job.

In a conventional technique, since the PP 205 pauses/resumes the processing of the print job after the PP 205 receives the notification, generation of the print data (print data generation) is paused/resumed and thus the print job is paused/resumed. However, in the present exemplary embodiment, a convenience in pausing the print job is improved by improving the processing performed by the PP 205 and the LM 207 when the user operates to pause the print job. The method (or the processing) will be described below in detail.

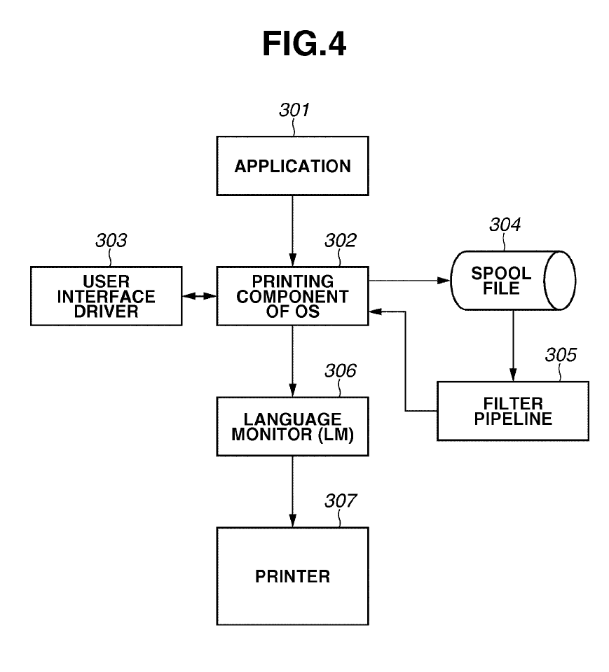

FIG. 4 illustrates an example of a configuration of the print system, which is referred to as the XPS print path, among the print systems applicable to the information processing apparatus. An arbitrary application 301 which includes a print processing function is installed in the information processing apparatus. Further, FIG. 4 exemplifies an embodiment in which a printer (printing device) 307 is connected to the information processing apparatus via the Internet such as a cable.

The application 301 can set print setting information to the printer 307 via a printing component 302 of the OS. The print setting information includes information necessary for printing, such as a type and a size of a paper on which a page generated by the application 301 is printed by the printer 307 and a paper feed port of the paper receiving device.

A user interface driver 303 notifies a list of options which can be set in each print setting information to the application 301 via the printing component 302 as well as includes an interface which can set various print settings.

The rendering data, that the application 301 requests for printing, is once stored in a spool file of the XPS file format and thereafter passed to a filter pipeline 305. The rendering data, which the application 301 requests for printing, includes print data such as document data and image data.

Accordingly, the print job is generated by the filter pipeline 305 and thus generated print job is output to the printer 307 as a print request.

The printing component 302 normally once spools the data in the spool file 304 in the form of the XPS data (spool processing of the OS). Then, the printing component 302 of the OS issues the print request to the filter pipeline 305 when the spool processing is completed.

The filter pipeline 305 reads print output information and the rendering data from the spool file 304 per page, generates print data per page, and requests to output the generated print data to the printer 307 via the printing component 302 to print the print data by the printer 307.

The filter pipeline 305 is supplied as a part of the printer driver after a maker of the printer 307 customizes the filter pipeline 305, and the filter pipeline 305 and the printer driver are installed into the hard disk.

The filter pipeline 305 performs the rendering processing and the color processing based on the obtained raster image data, thereby generating halftone data in which a color is separated into color components for respective color inks held by the printer 307.

Then, the filter pipeline 305 converts the print setting information into a print command and sends the converted print command to the printer 307 after the converted print command is attached to the print data to be printed.

The data output from the filter pipeline 305 is actually output to an LM 306 in the form of a transfer request. The LM 306 separates the print job into packets of a specific size and sequentially outputs the packets to the printer 307. The LM 306 is configured to output the print job to the printer 307 while the LM 306 recognizes a boundary between pages. This scheme is the same as what is done by the LM 207 in the GDI print path. Namely, the LM 306 analyzes the data of the print job at the end of the transfer processing in which the print job (or the print data) is transferred (output) to the printer 307 and outputs the print job (or the print data) while the LM 306 recognizes the boundary between pages. To pause the print processing at the right boundary between pages, it is provided that there is no retaining data relating to the print job remaining in the information processing apparatus after the processing of outputting the print job (or the print data) to the printer 307 while the LM 306 recognizes the boundary between pages.

In the XPS print path, the print queue screen provided by the OS is provided with a user interface which instructs to pause/resume the print job. According to the above operation, however, an instruction to pause/resume the print job is not notified to the filter pipeline 305 and the LM 306 but a flag indicative of pausing the print job is set to or removed from the job information of the print job. Therefore, to pause/resume the print job is not possible by pausing/resuming the processing in response to the notification from the printing component as it is done in the GDI print path (the GDI 202 in the GDI print path). In the present exemplary embodiment, innovation of the processing of the LM 306 enables the pausing processing of the print job in the XPS print path. The method (the processing) will be described below in detail.

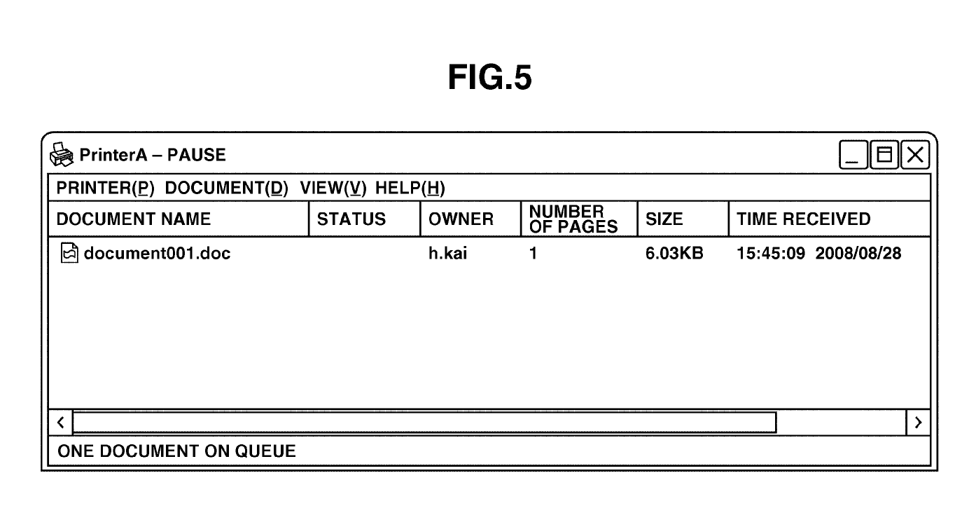

FIG. 5 illustrates an example of a screen displaying the print queue provided by the OS in both of the GDI print path and the XPS print path. A document name, a status, an owner, the number of pages, a size of spool data, and a time received are displayed for each print job.

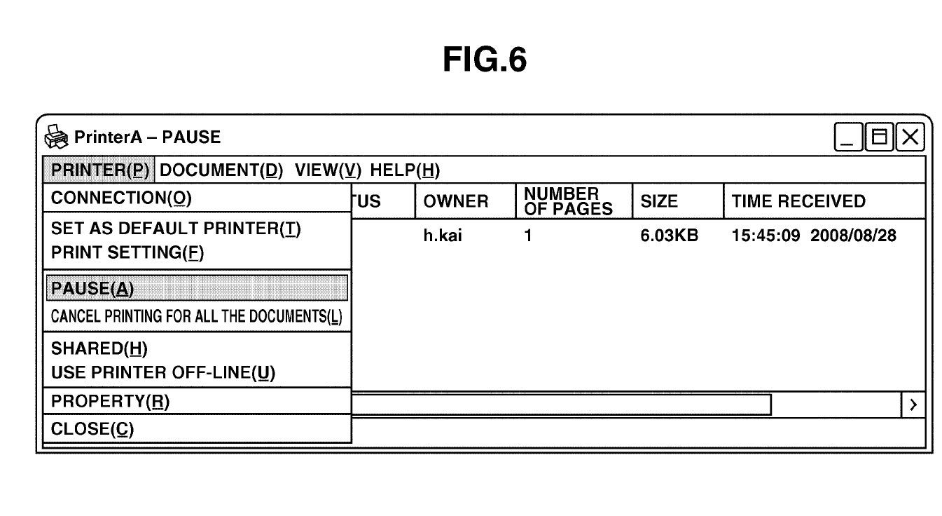

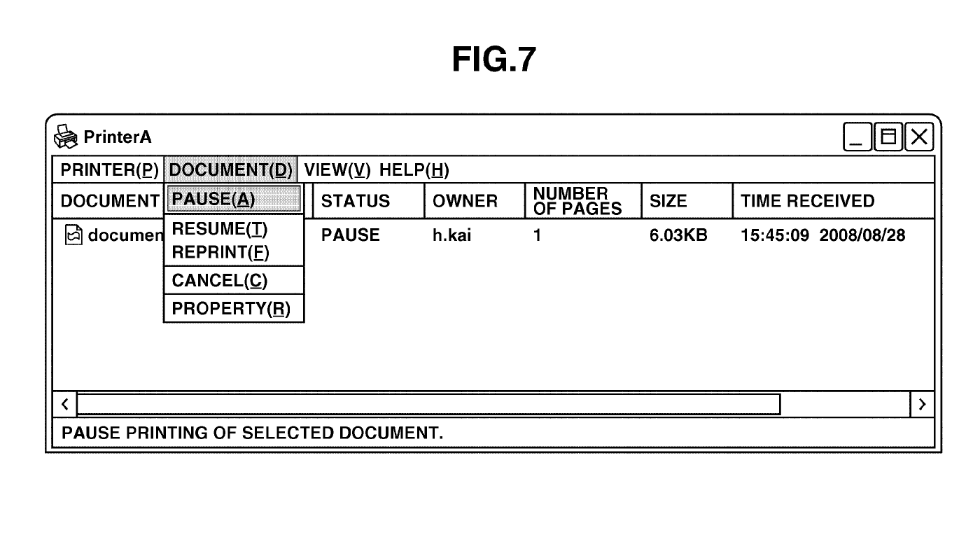

FIGS. 6 and 7 illustrate examples of a user interface for pausing the print processing on the print queue screen provided by the OS. FIG. 6 illustrates an example of an operation in the case where all of the print jobs, which are spooled for the purpose of being printed by the printer 208 or the printer 307, are paused at the same time. On the other hand, FIG. 7 illustrates an example of an operation in the case where only a specific print job is paused.

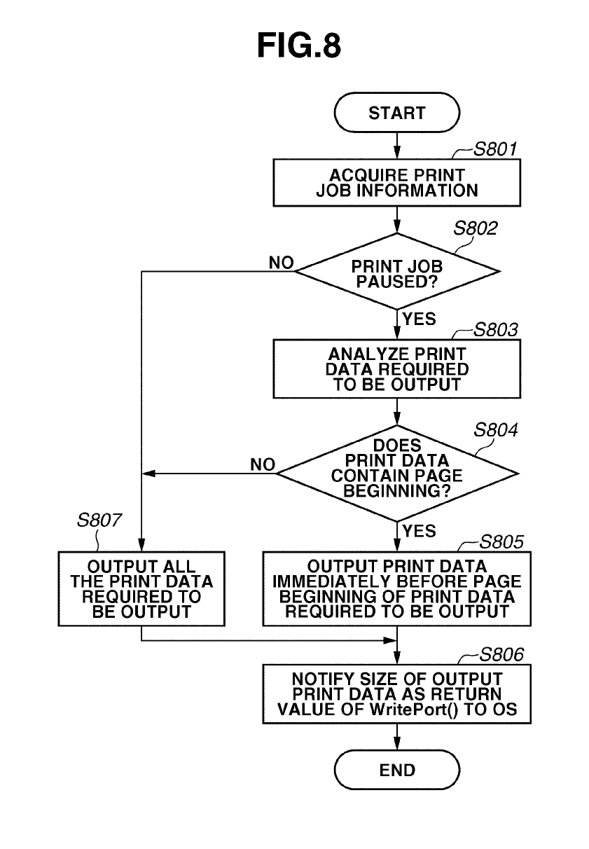

Now, print job pausing processing in the XPS print path according to the present exemplary embodiment will be described in detail with reference to FIG. 8. FIG. 8 is a flow chart illustrating a processing operation of processing to output a print job to the printer 307.

As described above, in the XPS print path, the operation to pause the print job performed on the print queue screen provided by the OS is not notified to the filter pipeline 305. Therefore, in the filter pipeline 305, it is not possible, as it is done in the GDI print path, to perform the processing to pause the print job based on the notification from the OS. In view of the above, in the XPS print path according to the present exemplary embodiment, the LM 306 pauses the processing to output the print job to the printer 307 in response to the operation to pause the print job which is performed on the print queue screen, thereby realizing the pausing of the print job.

FIG. 8 illustrates a processing operation of the processing of the LM 306 to output the print job to the printer 307. The processing to output the print job by the LM 306 is instructed by the printing component 302 calling a function of WritePort ( ) which is exported by the LM 306. As a parameter of the function of WritePort ( ) data and a size of the print job to be output to the printer 307 are passed to the LM 306. The LM 306 outputs the data of the print job to the printer 307 and a data size of the thus output data is returned to the printing component 302 as a return value of the function. Then, the printing component 302 repeats the processing to designate data of a constant size continuous to the data which could be output, and calls the function of WritePort ( ) until all the data of the print job would be output.

In step S801, the LM 306 acquires the print job information of the print job now in processing from the printing component 302. The print job information contains information indicating whether the print job is set in a paused status on the print queue.

In step S802, the LM 306 determines whether the print job now in processing is in the paused status. If the print job is not in the paused status (NO in step S802), the LM 306 advances the processing to step S807. In step S807, the LM 306 outputs all the print data, which are instructed to be output, to the printer 307 according to the function of WritePort ( ). In step S806, the LM 306 sets that the size (the number of bytes) of the print data, which has been output as the return value of the function of WritePort ( ) has been output to the OS and returns control to the printing component 302.

In step S802, if the LM 306 determines that the print job now in processing is set in a paused status (YES in step S802), the LM 306 advances the processing to step S803. In step S803, LM 306 analyzes the print data, which has been instructed to be output to the printer 307 according to the function of WritePort ( ) to the printer 307. In step S804, the LM 306 analyzes the print data based on information of a command identifier and the command length in a manner as described above and determines whether the print data contains the page beginning.

The determination by the LM 306 whether the page beginning is contained in the print data is performed in a manner described below. That is, the LM 306 determines that the print data contains the page beginning in the cases where (1) an initial start command (the Esc d command in the present exemplary embodiment) is displayed after the print job entry in the case of the beginning page of the print job, or (2) an initial start command is displayed after a paper discharge command (the FF command in the present exemplary embodiment) of a preceding page in the case of the pages other than the beginning page of the print job.

As described above, the printing component 302 designates only an output of the data of the constant size per each call according to the function of WritePort ( ). Therefore, the data designated according to the function of WritePort ( ) may be discontinued in the middle of the command, or may be discontinued after the paper discharge command and before the start command. To resolve the above problems, the LM 306 does not initialize the analysis status of the print job until the print job is completed even when the processing is returned from the function of WritePort ( ) to the printing component 302, but causes the analysis status of the print job to be continued in the next call of the function of WritePort ( ).

In step S804, the LM 306 advances the processing to step S807 when the LM 306 determines that the print data does not contain a page beginning (NO in step S804). In step S807, the LM 306 outputs all the print data, which has been instructed to be output to the printer 307 according to the function of WritePort ( ), to the printer 307. In step S806, the LM 306 sets that the size (the number of bytes) of the print data, which has been output as the return value of the function of WritePort ( ), has been output to the OS, and returns control to the printing component 302.

In step S804, when the LM 306 determines that the print data contains the page beginning (YES in step S804), the LM 306 advances the processing to step S805. In step S805, the LM 306 outputs the data immediately before the start command (Esc d command) at the recognized page beginning to the printer 307 as a result of the analysis of the print data. In step S806, the LM 306 sets that the LM 306 has output the size (the number of bytes) of the print data, which has been output as the return value of the function of WritePort ( ) and returns control to the print component 302.

Until the print job is completed, the printing component 302 repeatedly calls the function of WritePort ( ) of the LM 306. The LM 306 confirms the paused status of the print job with reference to the print job information at each time and, if the print job is in the paused status, the LM 306 controls so as to consider the page break as a breaking position and thus so as not to transfer the data after the command indicative of the page break to the printer 307. On the other hand, the LM 306 performs control, if the print job is released from the paused status, so as to resume the transfer processing.

As described above, each time the LM 306 calls the function of WritePort ( ) the LM 306 refers to the print job information of the print job now in processing and determines whether the print job is in the paused status. Then, if the LM 306 is in the paused status, the LM 306 outputs data immediately before the page beginning data detected by the analysis of the page information to the printer 307 and pauses to output the data until the print job is released from its paused status. Accordingly, the print job can be paused also in the XPS print path.

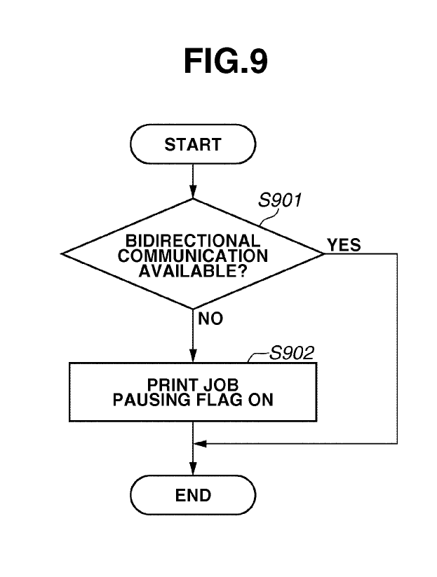

Now, print job pausing processing in the GDI print path according to the present exemplary embodiment will be described below in detail with reference to FIGS. 9 through 11.

As described above, in the GDI print path, conventionally, the GDI 202 notifies to pause/resume the print job to the PP 205 and the PP 205 pauses/resumes to generate the print data, thereby enabling to pause/resume the print job. However, when the print job employs the RAW format as the spool format, the print processing may be paused in the middle of the page, which adversely affects a print quality. In the present exemplary embodiment, even in the GDI print path, the above described conventional method is not used under the condition the LM 207 operates but a method, in which the print data is paused to be transferred from the LM 207 to the printer 208, is employed, thereby preventing the print job from being paused in the middle of the page. Processing by the PP 205 will be described in the cases where the LM 207 is not under the operating condition (when a bidirectional communication function is not available) and where the user operates to pause the print job or release the print job from the paused status.

FIG. 9 is a flow chart illustrating a processing operation of the PP 205 when the GDI 202 notifies the PP 205 to pause the print job as a result that the user operates to pause the print job in the print queue screen provided by the OS.

In step S901 in FIG. 9, the PP 205 determines whether the bidirectional communication function between the PP 205 and the printer 208 is available in the setting of the OS. If the bidirectional communication function is available in step S901 (YES in step S901), the PP 205 omits processing and returns control to the GDI 202. On the other hand, if the bidirectional communication function is not available (NO in step S901), the processing advances to step S902, and the PP 205 operates an internal variable of the PP 205 to make a flag, which designates that the print job is paused, available. If the bidirectional communication function between the PP 205 and the printer 208 is not available, i.e., if the LM 207 is set to be non-functioning, the processing causes the PP 205 to control to pause/resume the print job in the conventional manner. Since an initial value of the internal variable indicates that the print job is not to be paused, the PP 205 would not pause/resume the print job if the bidirectional communication between the PP 205 and the printer 208 is set to be available.

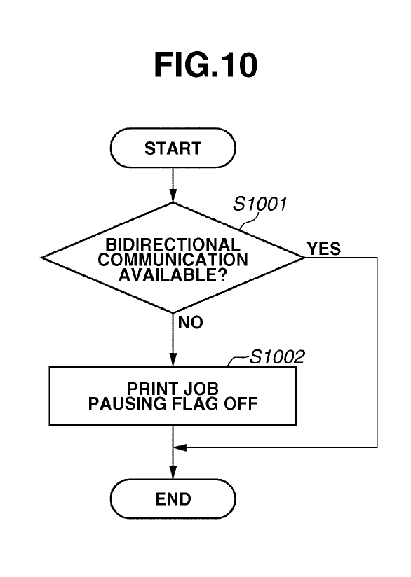

FIG. 10 is a flow chart illustrating a processing operation of the PP 205 when the GDI 202 notifies the resumption of the print job to the PP 205 as a result that the user operates to resume the print job in the print queue screen provided by the OS.

In S1001 in FIG. 10, the PP 205 determines whether the bidirectional communication function between the PP 205 and the printer 208 is available in the setting of the OS. If the bidirectional communication function is available in step S1001 (YES in step S1001), the PP 205 omits processing and returns control to the GDI 202. On the other hand, if the bidirectional communication function is not available (NO in step S1001), the processing advances to step S1002, in which the PP 205 operates the internal variable of the PP 205, thereby removing the flag which designates that the print job is to be paused. That is, the PP 205 changes the status of the print job from the paused status to the unpaused status.

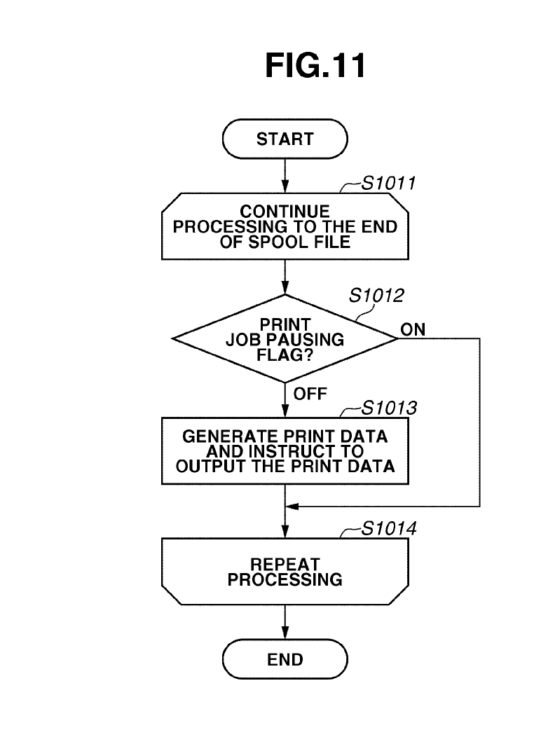

FIG. 11 is a flow chart illustrating a processing operation of print data generation processing performed by the PP 205.

The PP 205 acquires spool data from the spool file 204 by the GDI 202 calling the function of PrintDocumentOnPrintProcessor ( ). Then, the PP 205 generates print data and calls the function of WritePrinter ( ) which instructs to output the print data to the printer 208. The PP 205 repeats the above-described processing until the spool file ends (i.e., repeats steps S1101 through S1104).

At this time, the PP 205 refers to the internal variable which has been operated when the bidirectional communication function between the PP 205 and the printer 208 has been considered as being invalid in FIGS. 9 and 10, whereas the PP 205 controls so as not to generate or output the print data when the internal variable indicates that the print job is to be paused.

As a result of the above-described control, the PP 205 is uninvolved in the pausing/resuming processing of the print job when the setting is made so as to establish the bidirectional communication with the printer 208. To the contrary, the PP 205 operates to be involved in the pausing/resuming processing of the print job when the setting is made so as not to establish the bidirectional communication with the printer 208.

When the setting is made to establish the bidirectional communication with the printer 208, the PP 205 outputs the generated print data to the printer 208 via the LM 207. At this time, the LM 207 confirms the status of the print job in a similar manner as it is done by the LM 306 in the XPS print path, analyzes the print data, and performs the pausing/resuming processing of the print job.

As a result of the above-described control, in the GDI print path, the LM 207 controls the pausing/resuming processing of the print job when it is set that the LM 207 operates, whereas the PP 205 controls the pausing/resuming processing of the print job when it is set that the LM 207 does not operate. In other words, the print job would not be paused in the middle of the print processing of a page in the setting that the LM 207 operates, whereas at least the minimum pausing/resuming processing of the print job can be performed even if the print job is paused in the middle of the print processing of the page in the setting other than the above setting.

In each of the above-described exemplary embodiments, the LM monitors the paused status of the print job now in processing in the XPS print path, and the print data is paused to be transferred to the printer when the print job is in the paused status. Accordingly, the pausing processing of the print job can be realized in the XPS print path.

Further, in each of the above-described exemplary embodiments, the LM analyzes the print data and the print data is paused to be transferred at the boundary between pages when transferring the print data. Accordingly, print processing of the print data is prevented from being paused in the middle of the page, resulting in obtaining a satisfactory printing quality even when the print processing is once paused.

Still further, in each of the above-described exemplary embodiments, the LM pauses the print processing of the print job when it is set that the LM operates, whereas the print processor pauses the print processing of the print job when it is set that the LM does not operates, in the GDI print path. In view of the above, the maximum convenience can be obtainable depending on the settings in the pausing processing of the print job.

According to each of the above-described exemplary embodiments, the print processing can be paused in the XPS print path, and the print processing can also be paused, for example, at the boundary between pages even when the spool data is in the form of the RAW format in the GDI print path.

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2008-311338 filed Dec. 5, 2008, which is hereby incorporated by reference herein in its entirety.

What is claimed is:

1. An information processing apparatus comprising:
a data transfer unit configured to transfer print data to an image processing apparatus which is capable of communicating via a network,
wherein the data transfer unit recognizes a status of a job based on information of the job on a print queue and pauses or resumes processing to transfer the print data according to the recognized status.

2. The information processing apparatus according to claim 1, wherein the data transfer unit analyzes print data to be transferred and, when pausing processing to transfer the print data, pauses the processing at a position of a page break.

3. The information processing apparatus according to claim 2, wherein, when pausing processing to transfer the print data, the data transfer unit sets the position of a page break to a position of a page beginning.

4. The information processing apparatus according to claim 1, wherein the data transfer unit recognizes a status of the job based on the information of the job on the print queue at the end of processing to transfer the print data to the image processing apparatus, and pauses or resumes the processing to transfer the print data according to the recognized status.

5. The information processing apparatus according to claim 1, further comprising:
a print data generation unit configured to generate print data;
wherein the print data generation unit pauses processing to generate the print data in response to a pausing instruction when a function of the data transfer unit is set to be unavailable, and resumes the processing to generate the print data in response to a pausing instruction-removing instruction.

6. An information processing method for an information processing apparatus, the information processing method comprising:
transferring print data to an image processing apparatus which is capable of communicating via a network; and
recognizing a status of a job based on information of the job on a print queue and pausing or resuming processing to transfer the print data according to the recognized status.

7. The information processing method according to claim 6, further comprising:
analyzing print data to be transferred; and
when pausing processing to transfer the print data, pausing the processing at a position of a page break.

8. The information processing method according to claim 7, further comprising:
when pausing processing to transfer the print data, setting the position of a page break to a position of a page beginning.

9. The information processing method according to claim 6, further comprising:
recognizing a status of the job based on the information of the job on the print queue at the end of processing to transfer the print data to the image processing apparatus, and pausing or resuming the processing to transfer the print data according to the recognized status.

10. The information processing method according to claim 6, further comprising:
generating print data; and
pausing processing to generate the print data in response to a pausing instruction when a function to transfer the print data is unavailable, and resuming the processing to generate the print data in response to a pausing instruction-removing instruction.

11. A computer-readable storage medium storing a program for causing a computer to perform a method comprising:
transferring print data to an image processing apparatus which is capable of communicating via a network; and
recognizing a status of a job based on information of the job on a print queue and pausing or resuming processing to transfer the print data according to the recognized status.
